(19) United States
(12) Patent Application Publication
(10) Pub. No.: US 2026/0112982 A1
(43) Pub. Date: Apr. 23, 2026

(54) PIEZOELECTRIC GENERATOR AND METHOD OF MANUFACTURING THE SAME

(71) Applicants: Hyundai Motor Company, Seoul (KR); Kia Corporation, Seoul (KR); Livewalk, Jinju (KR)

(72) Inventors: Ju Hyeon Kim, Hwaseong (KR); Beom Suk Oh, Hwaseong (KR); Bong Sik Um, Jinju (KR)

(21) Appl. No.: 19/271,712

(22) Filed: Jul. 16, 2025

(30) Foreign Application Priority Data
Oct. 21, 2024 (KR) 10-2024-0144221

(51) Int. Cl. H02N 2/18; H02N 2/00

(52) U.S. Cl. CPC H02N 2/186; H02N 2/22

(57) ABSTRACT

A piezoelectric generator includes one or more unit structures, each including a substrate with an area larger than a piezoelectric element disposed thereon, and a printed circuit board electrically connected to at least two surfaces of the element. Optionally, the substrate is stainless steel (SUS), and the piezoelectric element is attached with an adhesive. Multiple unit structures may be stacked with intervening thermoplastic polyurethane films, and a jig can be provided to distribute loads. A method of manufacturing includes polarizing the piezoelectric element, bonding it to the substrate with an adhesive, attaching the printed circuit board, optionally degassing and thermally curing, and repeating these steps for layered structures.

### CROSS-REFERENCE TO RELATED APPLICATION

This application claims, under 35 U.S.C. § 119(a), the benefit of Korean Patent Application No. 10-2024-0144221, filed on Oct. 21, 2024, the entire contents of which are incorporated herein by reference.

### BACKGROUND

### Technical Field

The present disclosure relates to a piezoelectric generator.

### Background

Recently, interest in eco-friendly energy has been greatly increasing. For example, piezoelectric generation may generate electrical energy by applying pressure or vibration to a piezoelectric element.

A vibration power generator using vibration in a bridge is known. The vibration power generator may include a metal plate including a piezoelectric element fixed in a cantilever form. When vibration is applied, the metal plate may deform to generate electrical energy by the piezoelectric phenomenon.

Conventional piezoelectric generation technologies have generally adopted a method of causing vibration in a piezoelectric element. However, this power generation technology has a disadvantage of low power generation.

The above information disclosed in this Background section is only for enhancement of understanding of the background of the disclosure, and therefore it may contain information that does not form the prior art that is already known to one having ordinary skill in the art.

### SUMMARY OF THE DISCLOSURE

The present disclosure has been made in an effort to solve the above-described problems associated with the prior art and it is one object of the present disclosure to provide a piezoelectric generator that is capable of increasing piezoelectric power generation.

It is another object of the present disclosure to provide a piezoelectric generator that is capable of enhancing an eco-friendly decarbonization effect.

The objects of the present disclosure are not limited to those described above. Other objects of the present disclosure will be clearly understood by a person having ordinary knowledge in the technical field to which the present disclosure pertain (hereinafter referred to as “one having ordinary skill in the art”).

In order to achieve the objects of the present disclosure as described above and to perform the characteristic function of the present disclosure described below, the features of the present disclosure are as follows.

In some embodiments, the present disclosure provides a piezoelectric generator including at least one unit structure, the at least one unit structure including a substrate, a piezoelectric element disposed on the substrate, and a printed circuit board disposed on the piezoelectric element and connected to a first surface and a second surface of the piezoelectric element, wherein an area of the substrate is larger than an area of the piezoelectric element.

In aspects, an area of the substrate suitably may be for example up to or at least 1, 2, 3, 5, 8, 10, 12, 15, 20, 25, 30, 40, 50, 60, 70, 80, 90 or 100 percent larger than an area of the piezoelectric element.

The piezoelectric element may include an electrode for polarization. The printed circuit board may have a first region electrically connected to the first surface of the piezoelectric element, where an electrode for polarization is formed on that first surface, and a second region separated from the first region that may be electrically connected to the second surface through the substrate. A first tab may be formed in the first region, a second tab may be formed in the second region, and the two tabs may be electrically connectable to a power storage device. The printed circuit board may be a flexible circuit board. An adhesive agent may be applied between the substrate, the piezoelectric element, and the printed circuit board, and this adhesive agent may be conductive. In some examples, multiple unit structures may be included, and a thermoplastic polyurethane film may be disposed between adjacent unit structures. A jig may also be provided to allow the piezoelectric generator to be inserted and to distribute a load applied to it, and the jig may include a lower plate, a shim plate and an elastic body alternately stacked on the lower plate, and an upper plate coupled to the lower plate.

In some embodiments, a piezoelectric generator comprises at least one unit structure. The at least one unit structure may include a stainless steel (SUS) substrate having a first area, and a piezoelectric ceramic plate having a second area smaller than the first area; the piezoelectric ceramic plate may be polarized on at least one major surface and may be adhered to the stainless steel (SUS) substrate via an adhesive. A flexible printed circuit board (FPCB) may be connected to a silver electrode formed on the piezoelectric ceramic plate so that the FPCB may be electrically connected to the at least one major surface of the piezoelectric ceramic plate. An area of the stainless steel (SUS) substrate may be larger than an area of the piezoelectric ceramic plate. For example, in aspects, an area of the steel substrate suitably may be up to or at least 2, 3, 5, 8, 10, 12, 15, 20, 25, 30, 40, 50, 60, 70, 80, 90 or 100 percent larger than an area of the piezoelectric ceramic plate.

In some embodiments, the present disclosure provides a method of manufacturing a piezoelectric generator, the method including subjecting a first piezoelectric element including a first electrode to polarization, attaching the first piezoelectric element to a first substrate, and attaching a first printed circuit board to the first piezoelectric element.

Attaching a first piezoelectric element to a first substrate may be carried out using an adhesive agent. This method may also include degassing the attached first piezoelectric element and first substrate. Attaching a first printed circuit board to the first piezoelectric element may be performed using an adhesive agent, and degassing may be performed after attaching the first printed circuit board to the first piezoelectric element. In some examples, the method may further comprise attaching the first piezoelectric element to the first substrate through an adhesive agent, degassing the attached first piezoelectric element and first substrate, attaching the first printed circuit board to the first piezoelectric element through an adhesive agent, degassing the attached first piezoelectric element and first printed circuit board, and thermally curing the attached first piezoelectric element, first substrate, and first printed circuit board.

The method may also include placing a first film on the first printed circuit board, attaching a second piezoelectric element comprising a polarized second electrode to a second substrate, attaching a second printed circuit board to the second piezoelectric element, and stacking the attached second substrate, the second piezoelectric element, and the second printed circuit board on the first film. In additional aspects, a second film may be placed on the first substrate, a third piezoelectric element comprising a polarized third electrode may be attached to a third substrate, a third printed circuit board may be attached to the third piezoelectric element, and the attached third substrate, the third piezoelectric element, and the third printed circuit board may be stacked on the second film.

As discussed, the method and system suitably include use of a controller or processer.

In another embodiment, vehicles are provided that comprise an apparatus as disclosed herein.

Other embodiments of the disclosure are discussed infra.

### BRIEF DESCRIPTION OF THE DRAWINGS

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 illustrates a piezoelectric generator according to an embodiment of the present disclosure;

FIG. 2 illustrates a unit structure of a piezoelectric generator according to an embodiment of the present disclosure;

FIG. 3 illustrates a printed circuit board of the unit structure of the piezoelectric generator according to an embodiment of the present disclosure;

FIG. 4 is a flowchart illustrating a process of manufacturing the unit structure of the piezoelectric generator according to an embodiment of the present disclosure;

FIG. 5 is a perspective view illustrating a jig for the piezoelectric generator according to an embodiment of the present disclosure;

FIG. 6 is a cross-sectional view taken along line A-A of FIG. 5;

FIG. 7 illustrates a voltage waveform output for a compressive load repeatedly applied to the piezoelectric generator according to an embodiment of the present disclosure; and

FIGS. 8A and 8B illustrate electrical output characteristics depending on vertical load of a piezoelectric generator including a 6-layer unit structure and a 15-layer unit structure according to an embodiment of the present disclosure, respectively.

### DETAILED DESCRIPTION

The specific structural and functional descriptions presented in the embodiments of the present disclosure are provided merely for better understanding of embodiments according to the concept of the present disclosure, and the embodiments according to the concept of the present disclosure may be implemented in various forms. In addition, the embodiments described herein should not be construed as being limited, but should be understood to include all modifications, equivalents, or substitutes included in the spirit and technical scope of the present disclosure.

It will be understood that, although the terms “first,” “second”, etc., may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element.

In addition, it will be understood that, when an element is referred to as being “bonded to” or “connected to” another element, it may be directly on the other element, or an intervening element may also be present. On the other hand, it will also be understood that, when an element is referred to as being “directly connected to” or “directly contacts” another element, it may be directly under the other element, or an intervening element may also be present. Other expressions to describe the relationship between components, such as “between” and “directly between” or “adjacent to” and “directly adjacent to,” should be interpreted similarly.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Like reference numbers refer to like elements throughout the description of the figures. Meanwhile, the terms used herein are merely provided for description of embodiments and should not be construed as limiting the present disclosure. Singular forms are intended to include the plural meaning as well, unless the context clearly indicates otherwise. It will be further understood that the terms “comprise,” “include,” and/or “have,” when used in this specification, specify the presence of stated components, steps, operations, and/or elements, but do not preclude the presence or addition of one or more other components, steps, operations, and/or elements. Hereinafter, the present disclosure will be described in detail with reference to the attached drawings.

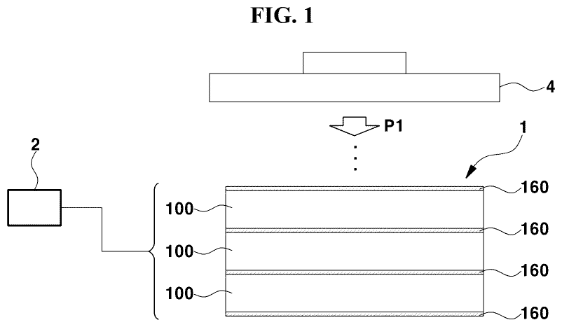

As shown in FIG. 1, a piezoelectric generator 1 according to the present disclosure may generate electricity based on the piezoelectric principle. The piezoelectric generator 1 may generate electricity when a load P1 is applied to the piezoelectric generator 1. In one embodiment, the piezoelectric generator 1 includes a unit structure 100. The piezoelectric generator 1 may include a plurality of unit structures 100 that are stacked on each other. Each unit structure 100 may generate electricity when a load is applied thereto.

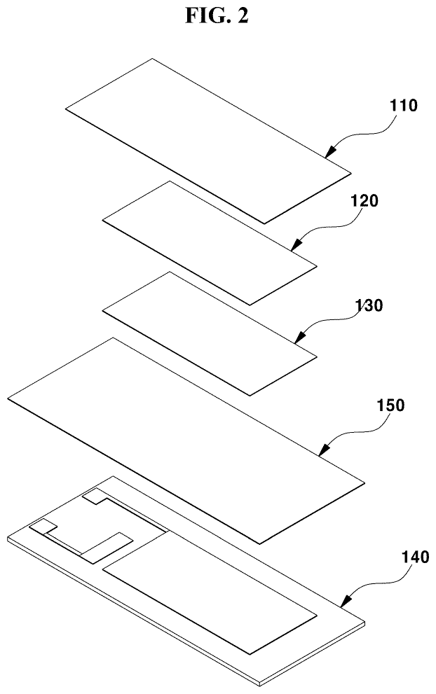

As shown in FIG. 2, the unit structure 100 includes a substrate 110. The substrate 110 may minimize the destruction of the piezoelectric element 120 and maximize the deformation of the piezoelectric element 120 by an external load. In addition, the substrate 110 may stably support the piezoelectric element 120 and provide a base for electrical connection of components of the unit structure 100. As a non-limiting example, the substrate 110 may be made of stainless steel.

The unit structure 100 further includes the piezoelectric element 120. The piezoelectric element 120 may be a material having piezoelectric properties. For example, the piezoelectric element 120 may be made of a piezoelectric ceramic. As a non-limiting example, the piezoelectric element 120 may be based on lead zirconate titanate (PZT). The piezoelectric element 120 may convert mechanical effects, such as pressure or vibration, applied to the piezoelectric element 120 into electrical signals, and vice versa. In one embodiment, the area of the piezoelectric element 120 may be formed smaller than the area of the substrate 110.

In one embodiment, the piezoelectric element 120 may undergo a firing process. Specifically, the piezoelectric element 120 may undergo a firing process at about 1,000° C. In one embodiment, the piezoelectric element 120 may be manufactured through a polishing process. Specifically, the surface roughness of the piezoelectric element 120 may be reduced by the polishing process after the firing process. The polishing process may provide the piezoelectric element 120 with a smooth surface.

The unit structure 100 includes an electrode 130. As a non-limiting example, the electrode 130 may be made of silver (Ag). However, silver is merely an example and other materials that perform similar functions may be used. The electrode 130 may be applied to at least one of the two surfaces of the piezoelectric element 120. For example, the electrode 130 may be applied to the surface of the piezoelectric element 120 with a thickness of about 5 micrometers (m). The electrode 130 may transmit an electrical signal and induce polarization of the piezoelectric element 120.

According to an embodiment of the present disclosure, a polarization process may be performed on the piezoelectric element 120. In the polarization process, the electrode 130 is applied to a thickness of about 5 μm to a first surface of the piezoelectric element 120. Then the piezoelectric element 120 to which the electrode 130 is applied is heated to about 400° C. and then cooled. Through the polarization process, the piezoelectric element 120 may have excellent crystal orientation with the same crystal orientation. In one example, the polarization process may be performed on both surfaces of the piezoelectric element 120, i.e., the first surface and the second surface.

The unit structure 100 may include a printed circuit board 140. The printed circuit board 140 may extract an electrical signal of the piezoelectric element 120 and enable an electrical connection. In one embodiment, the printed circuit board 140 may be a flexible printed circuit board (FPCB). An electrode pattern may be printed on the printed circuit board 140. In one embodiment, the electrode pattern may be an aluminum electrode pattern.

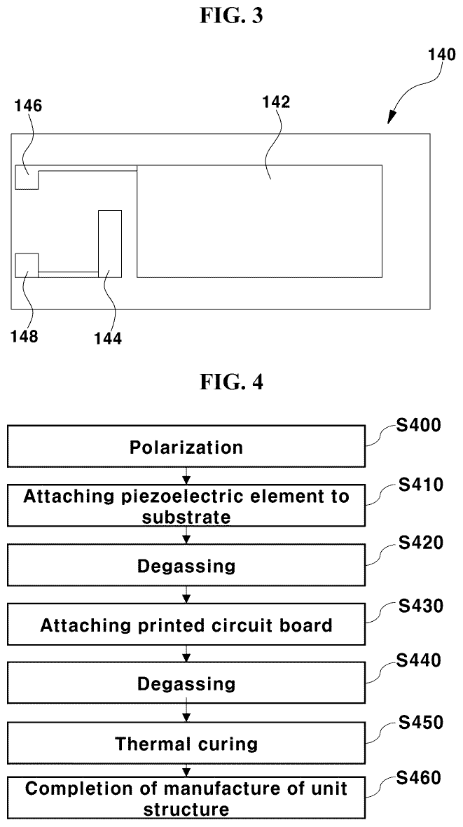

As shown in FIG. 3, the printed circuit board 140 is connected to the piezoelectric element 120. The printed circuit board 140 includes a first region 142 connected to a first surface of the piezoelectric element 120 and a second region 144 connected to a second surface of the piezoelectric element 120. The first region 142 and the second region 144 may be electrically separated. The first region 142 may be connected to the first surface of the piezoelectric element 120 to which the electrode 130 is applied, and the second region 144 may be connected to the second surface of the piezoelectric element 120. According to one embodiment, the first region 142 may be directly connected to the first surface of the piezoelectric element 120, and the second region 144 may be connected to the second surface of the piezoelectric element 120 through the substrate 110, or the substrate 110 and an adhesive agent 150. For this purpose, the substrate 110 may be configured to have a larger area than the piezoelectric element 120.

A first tab 146 may be formed in the first region 142, and a second tab 148 may be formed in the second region 144. Therefore, the current generated in the piezoelectric element 120 when pressure is applied may be extracted through the first tab 146 and the second tab 148.

The unit structure 100 may further include the adhesive agent 150. As a non-limiting example, the adhesive agent 150 may be a conductive adhesive agent. As a non-limiting example, the adhesive agent 150 may be a conductive epoxy. The adhesive agent 150 may enable the substrate 110, the piezoelectric element 120, and the printed circuit board 140 to be bonded to each other and to be stably electrically connected to each other. In one embodiment, a thermal curing process may be performed after applying the adhesive agent 150 to further enhance the adhesive strength.

According to an embodiment of the present disclosure, the piezoelectric generator 1 may further include a film 160. The film 160 may be disposed between adjacent unit structures 100. The film 160 may improve load distribution and induce deformation of the piezoelectric element 120, thereby enhancing power generation performance. As a non-limiting example, the film 160 may be formed of a transparent material. As a non-limiting example, the film 160 may be formed of thermoplastic polyurethane (TPU). In one embodiment, the piezoelectric generator 1 may include a plurality of films 160 having different thicknesses. For example, two types of films 160 having a thickness of 0.5 millimeters (mm) and 1.0 mm may be used.

The piezoelectric generator 1 may be connected to a power storage device 2. Specifically, electricity generated by applying a load to the piezoelectric generator 1 may be stored in the power storage device 2 connected through the tabs 146 and 148 of the printed circuit board 140 of each unit structure 100. The electricity stored in the power storage device 2 may be supplied to a desired area.

As shown in FIG. 4, the unit structure 100 and the piezoelectric generator 1 may be formed through a series of processes.

At operation S400, polarization is performed on the piezoelectric element 120 including the electrode 130. In one embodiment, a silver electrode 130 is applied to a thickness of about 5 m to the first surface of the piezoelectric element 120. Then heating and cooling are performed. In one embodiment, the piezoelectric element 120 to which the silver electrode 130 is applied may be heated to about 400° C. and then cooled. The polarization process imparts excellent crystal orientation to the piezoelectric element 120.

At operation S410, the adhesive agent 150 is applied to the substrate 110, and the piezoelectric element 120 is attached to the substrate 110. The second surface of the piezoelectric element 120 (i.e., the surface of the piezoelectric element 120 on which the electrode 130 is not formed) may be attached to the substrate 110.

At operation S420, degassing may be performed. The piezoelectric element 120 attached to the substrate 110 is inserted into a vacuum packaging machine and degassed. Through the degassing, pores on the attachment surface of the piezoelectric element 120 and the substrate 110 may be removed.

At operation S430, the printed circuit board 140 is attached to the piezoelectric element 120. The adhesive agent 150 is applied to the first surface of the piezoelectric element 120 (i.e., a surface of the piezoelectric element 120 on which the electrode 130 is formed), and the first surface of the piezoelectric element 120 is attached to the first region 142 of the printed circuit board 140. The printed circuit board 140 and the piezoelectric element 120 are disposed such that the first region 142 of the printed circuit board 140 does not go beyond the range of the electrode 130 of the piezoelectric element 120. The second region 142 of the printed circuit board 140 may come into contact with the substrate 110 and may be electrically connected to the second surface of the piezoelectric element 120 through the substrate 110.

At operation S440, degassing may be performed on the unit structure 100 including the substrate 110, the piezoelectric element 120, and the printed circuit board 140 prepared in the previous operation S430. Air bubbles present on the surface of the piezoelectric element 120 bonded to the printed circuit board 140 may be removed through a vacuum packaging machine.

At operation S450, thermal curing may be performed. The unit structure 100 may be disposed in a dehumidifying oven at a predetermined temperature for a predetermined period of time, and thermal curing may be performed on the adhesive agent 150. Specifically, the unit structure 100 may be disposed in the dehumidifying oven at a temperature of about 60° C. for about 3 hours or more to thermally cure the adhesive agent 150. As described above, thermal curing may improve adhesive strength. Thus, manufacture of the unit structure 100 may be completed at operation S460.

A plurality of unit structures 100 may be stacked to form a piezoelectric generator 1. The film 160 may be interposed between adjacent unit structures 100.

The piezoelectric generator 1 may generate electricity by an applied load. When the load is applied to the piezoelectric generator 1, electricity may be stored in a power storage device 2 connected to the piezoelectric generator 1. In one embodiment, the load may be applied through a press 4, which may be a hydraulic press. The press 4 may directly apply pressure to the piezoelectric generator 1. In another embodiment, the press 4 may apply pressure to the piezoelectric generator 1 through a jig 200.

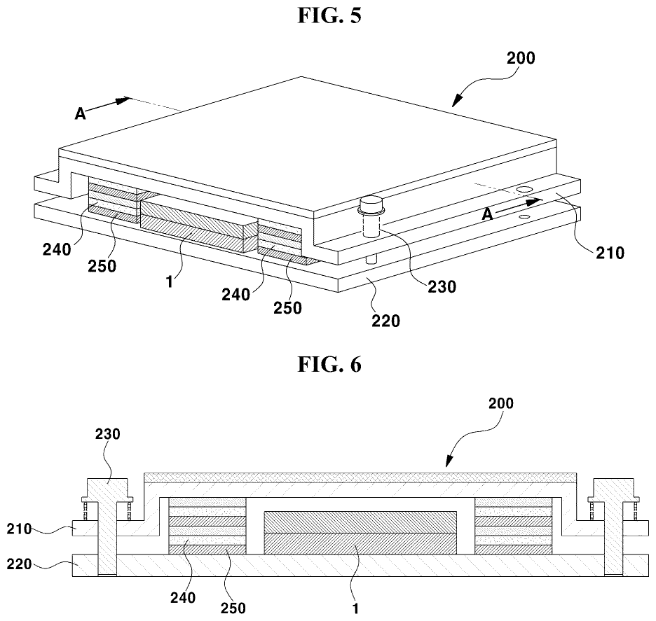

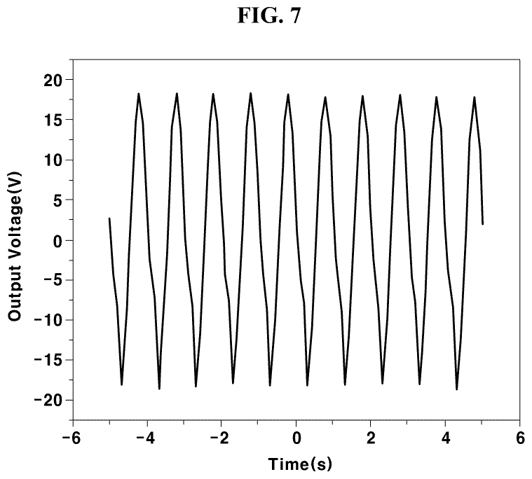

As shown in FIGS. 5 and 6, the jig 200 is configured to distribute the load applied to the piezoelectric generator 1. Efficient power generation is possible only when the load is evenly distributed to the piezoelectric generator 1. Accordingly, according to the present disclosure, the piezoelectric generator 1 may be inserted into the jig 200, and the press 4 may press the piezoelectric generator 1 through the jig 200.

The jig 200 includes an upper plate 210 and a lower plate 220. The upper plate 210 and the lower plate 220 are configured to distribute the applied load. The upper plate 210 and the lower plate 220 may be connected to each other through a spring bolt 230. The spring bolt 230 may also function to distribute the load. A shim plate 240 and an elastic body 250 may be stacked between the upper plate 210 and the lower plate 220. The shim plate 240 is configured to adjust the height, and the elastic body 250 is configured to function as a damper. As a non-limiting example, the elastic body 250 may be an elastomer. In one embodiment, the shim plate 240 and the elastic body 250 may be alternately disposed in the jig 200. It has been experimentally found that, when the load of the press 4 is 500 tons, the jig 200 may distribute the load up to 180 tons, which is the maximum load of the piezoelectric generator 1.

Power generation by the piezoelectric generator 1 may be performed as follows. The piezoelectric generator 1 or the jig 200 in which the piezoelectric generator 1 is inserted is pressed by the press 4. When piezoelectric generator 1 or the jig 200 is repeatedly pressed at a specific cycle (e.g., 1 Hz), a voltage waveform as shown in FIG. 7 may be output.

In the experiment, the press 4 used herein is capable of measuring a dynamic loading of up to 1.2 meganewtons (MN) and a displacement of up to 125 mm. The piezoelectric generator 1 may be prepared to include two types of 6-layer unit structures 100 (each including a film 160 with 0.5 mm and a film 160 with 1.0 mm) and two types of 15-layer unit structures 100 (a total of 17 layers of films 160 with 0.5 mm and films 160 with 1.0 mm).

FIG. 7 shows a voltage waveform output from a piezoelectric generator including a 6-layer unit structure 100 under test conditions in which a compressive load is repeatedly applied at a cycle of 1 Hz under a state in which a vertical load of 25 tons is applied. It can be seen that a voltage waveform of about 36 volts (V) was output with a peak-to-peak value. In this experiment, the voltage output to the oscilloscope electrically connected to the piezoelectric generator was evaluated while increasing the applied vertical load in units of 5 tons and the generated power was calculated by a connected variable resistor.

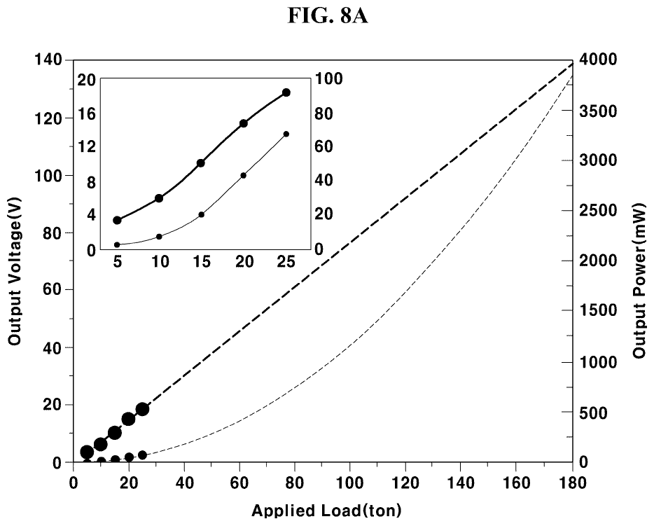

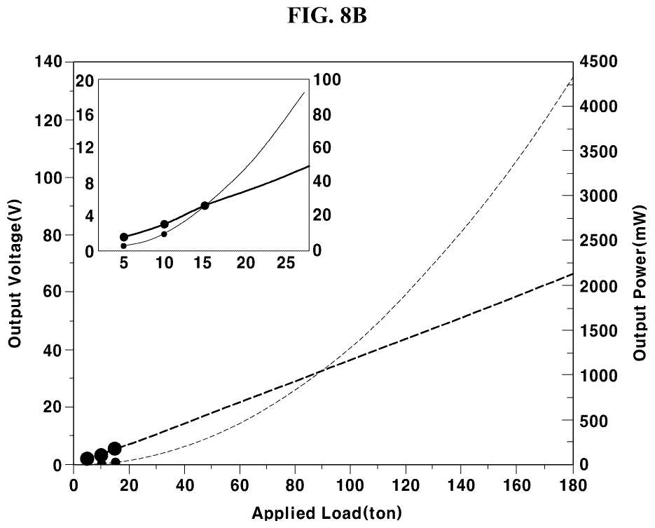

FIGS. 8A and 8B illustrate the output voltage and output power characteristics as a function of the increase in vertical load of a piezoelectric generator including a 6-layer unit structure 100 and a 15-layer unit structure 100, respectively. In the 6-layer piezoelectric generator, a test was performed up to 25 tons and a load resistance of 5 kilohm (kΩ) was applied, whereas, in the 15-layer piezoelectric generator, a test was performed up to 15 tons, and a load resistance of 1 kΩ was applied to evaluate the output power characteristics. Both test specimens had no damage due to deformation of the piezoelectric element for the increasing test load and maintained the normal circular shape up to the applied test load range described above. However, the measurement was stopped because deformation occurred in the surface layer due to the slip phenomenon of the TPU material film 160 located on the upper and lower surfaces of the test specimen. Based on the output electric signal tested up to the corresponding load range, the output voltage and output power characteristics in response to the applied load were evaluated and the trend behavior was predicted through a polynomial function up to the maximum destruction load of 180 tons of the piezoelectric ceramic based on the conventional design. The result of the test showed that both tests had similar behaviors. The output voltage linearly increased as the test load increased, and the output power increased exponentially. It was predicted based on the trend function that, when a load of about 180 tons is applied, a 6-layer piezoelectric generator will be able to generate about 3.8 watts (W) of power, and a 15-layer piezoelectric generator will be able to generate about 4.3 W of power.

Meanwhile, the expected power generation of the piezoelectric generator stacked at a height of 10 centimeters (cm) (i.e., 100 mm) was measured. It is predicted that, when stacked to a height of 10 cm, 33 unit structures will be obtained, and, when the damper is applied based on the power generation per sheet, the unit structure is assumed to be 3 mm per piezoelectric generator. In other words, 33.3 sheets may be stacked in 10 cm (100 mm). The expected values when the minimum and maximum generated power are calculated based on the power generation of the reference model are shown in Table 1 below. As described above, in the art, research was mainly conducted using vibration in piezoelectric power generation, resulting in very low power generation. However, it can be seen that, when impact is used as in the present disclosure, the power generation is remarkably high, compared to a conventional cantilever method.

TABLE 1

| | | | | | Stack | |
|---|---|---|---|---|---|---|
| Number of unit | Power | Minimum | Maximum | | height | |
| structures | (W) | power (W) | power (W) | Size (mm) | (mm) | Remarks |
| 4 | 0.4-0.5 | 50 | 80 | 100X5X0.5 | 0.5 | Parallel |
| | | | | | | connection |
| 33.3 | — | 1665 | 2664 | 100X5X3 | 100 | 50WX33.3 |
| | | | | | | 80WX33.3 |
| About 40% is | — | 667 | 1065 | — | — | |
| estimated when | | | | | | |
| conversion | | | | | | |
| loss is applied. | | | | | | |

When the generated power was predicted along with the comparative model, the generated power was 2.79 W, corresponding to about 7 times of 0.4 W, which is the generated power of the comparative model.

1. Generated power of 15-layer piezoelectric generator: 2.79 W

2. Single power of 1-layer unit structure: 0.4 to 0.5 W (comparative model)

3. Minimum and maximum generated power of 1-layer unit structure: 50 to 80 W (comparative model)

The generated power of the 15-layer piezoelectric generator measured under the conditions was 2.79 W, which was divided by the generated power of each layer to calculate an average increase rate per layer. The single power, minimum power, and maximum power ranges for simulated 100-layer and 250-layer stacks were estimated based on this increase rate.

1. Calculation of minimum and maximum generated power when 15 layers are stacked.
Since the generated power when 15 layers are stacked is 2.79 W, the minimum and maximum power are as follows.
Minimum power: 50 W/0.4 W×2.79 W
Maximum power: 80 W/0.5 W×2.79 W

2. Calculation of single power, minimum and maximum power when 100 layers are stacked.
Single power: 2.79 W/15×100
Minimum power: 50 W/0.4 W×(2.79 W/15×100)
Maximum power: 80 W/0.5 W×(2.79 W/15×100)

3. Calculation of single power, minimum power and maximum power when 250 layers are stacked
Single power: 2.79 W/15×250
Minimum power: 50 W/0.4 W×(2.79 W/15×250)
Maximum power: 80 W/0.5 W×(2.79 W/15×250)

Based on the expected power, the carbon reduction effect for the same period is analyzed as follows.

1. Carbon dioxide emission factor (greenhouse gas emission factor, 2011) when 1 kilowatt (kWh) is generated in Korea: 0.4594 (tCO2eq/MWh)

2. Carbon dioxide emissions (tCO2eq/year)=power (electricity) usage (MWh/year)×emission factor (tCO2eq/MWh)

When the electricity usage is converted to generated power, values such as carbon dioxide emissions are obtained, and the results are shown in Table 2 below.

TABLE 2

| Number | Minimum | Maximum | | |
|---|---|---|---|---|
| of | annual | annual | Minimum | Maximum |
| stacked | consumed | consumed | CO₂ | CO₂ |
| unit | energy | energy | emission | emission |
| structures | (kWh) | (kWh) | (tCO2eq) | (tCO2eq) |
| 15 | 611.01 | 782.0928 | About 0.2803 | About 0.3592 |
| 100 | 4073.4 | 5213.952 | About 1.8701 | About 2.3932 |
| 250 | 10183.5 | 13034.88 | About 4.6798 | About 5.9863 |

As such, the present disclosure can significantly increase the power generation and further enhance the eco-friendly decarbonization effect by applying impact or shock to the piezoelectric generator.

According to the present disclosure, a piezoelectric generator capable of increasing piezoelectric generation is provided.

According to the present disclosure, a piezoelectric generator capable of increasing eco-friendly decarbonization effects is provided.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in these examples without departing from the principles and spirit of the present disclosure, the scope of which is defined in the appended claims and their equivalents.

What is claimed is:

1. A piezoelectric generator comprising at least one unit structure, the at least one unit structure comprising:
a substrate;
a piezoelectric element disposed on the substrate; and
a printed circuit board disposed on the piezoelectric element and connected to a first surface and a second surface of the piezoelectric element,
wherein an area of the substrate is larger than an area of the piezoelectric element.

2. The piezoelectric generator of claim 1, wherein the piezoelectric element comprises an electrode for polarization.

3. The piezoelectric generator of claim 1, wherein the printed circuit board comprises:
a first region electrically connected to the first surface of the piezoelectric element wherein an electrode for polarization is formed on the first surface; and
a second region separated from the first region and electrically connected to the second surface through the substrate.

4. The piezoelectric generator of claim 3, wherein a first tab is formed in the first region, a second tab is formed in the second region, and the first tab and the second tab are configured to be electrically connected to a power storage device.

5. The piezoelectric generator of claim 1, wherein the printed circuit board is a flexible circuit board.

6. The piezoelectric generator of claim 1, further comprising an adhesive agent applied between the substrate, the piezoelectric element, and the printed circuit board.

7. The piezoelectric generator of claim 6, wherein the adhesive agent is conductive.

8. The piezoelectric generator of claim 1, comprising a plurality of the unit structures.

9. The piezoelectric generator of claim 8, wherein a thermoplastic polyurethane film is disposed between the unit structures adjacent to each other.

10. The piezoelectric generator of claim 8, further comprising a jig configured to allow the piezoelectric generator to be inserted into the jig and to distribute a load applied to the piezoelectric generator.

11. The piezoelectric generator of claim 10, wherein the jig comprises:
a lower plate;
a shim plate and an elastic body alternately stacked on the lower plate; and
an upper plate coupled to the lower plate.

12. A piezoelectric generator comprising at least one unit structure, the at least one unit structure comprising:
a stainless steel (SUS) substrate having a first area;
a piezoelectric ceramic plate having a second area smaller than the first area, wherein the piezoelectric ceramic plate is polarized on at least one major surface, and is adhered to the stainless steel (SUS) substrate via an adhesive; and
a flexible printed circuit board (FPCB) connected to a silver electrode formed on the piezoelectric ceramic plate so that the FPCB is electrically connected to the at least one major surface of the piezoelectric ceramic plate,
wherein an area of the stainless steel (SUS) substrate is larger than an area of the piezoelectric ceramic plate.

13. A method of manufacturing a piezoelectric generator, the method comprising:
subjecting a first piezoelectric element comprising a first electrode to polarization;
attaching the first piezoelectric element to a first substrate; and
attaching a first printed circuit board to the first piezoelectric element.

14. The method of claim 13, wherein the attaching the first piezoelectric element to the first substrate comprises attaching the first piezoelectric element to the first substrate using an adhesive agent.

15. The method of claim 14, further comprising degassing the attached first piezoelectric element and first substrate.

16. The method of claim 13, wherein the attaching the first printed circuit board to the first piezoelectric element comprises attaching the first printed circuit board to the first piezoelectric element using an adhesive agent.

17. The method of claim 16, wherein the degassing is performed after attaching the first printed circuit board to first piezoelectric element.

18. The method of claim 13, further comprising:
attaching the first piezoelectric element to the first substrate through an adhesive agent;
degassing the attached first piezoelectric element and first substrate;
attaching the first printed circuit board to the first piezoelectric element through an adhesive agent;
degassing the attached first piezoelectric element and first printed circuit board; and
thermally curing the attached first piezoelectric element, first substrate and first printed circuit board.

19. The method of claim 13, comprising:
placing a first film on the first printed circuit board;
attaching a second piezoelectric element comprising a polarized second electrode to a second substrate;
attaching a second printed circuit board to the second piezoelectric element; and
stacking the attached second substrate, the second piezoelectric element, and the second printed circuit board on the first film.

20. The method of claim 19, further comprising:
placing a second film on the first substrate;
attaching a third piezoelectric element comprising a polarized third electrode to a third substrate;
attaching a third printed circuit board to the third piezoelectric element; and
stacking the attached third substrate, the third piezoelectric element, and the third printed circuit board on the second film.
